(19) United States
(12) Patent Application Publication
(10) Pub. No.: US 2008/0241810 A1
(43) Pub. Date: Oct. 2, 2008

(54) CUSTOMIZED MODULAR LEARNING ENVIRONMENT

(76) Inventor: Edwin S. Flores, Dallas, TX (US)

Correspondence Address: CHALKER FLORES, LLP, 2711 LBJ FRWY, Suite 1036, DALLAS, TX, 75234, US

(21) Appl. No.: 12/058,692

(22) Filed: Mar. 29, 2008

Related U.S. Application Data
(60) Provisional application No. 60/908,867, filed on Mar. 29, 2007.

(51) Int. Cl. G09B 19/00

(52) U.S. Cl. 434/350; 434/365; 709/204

(57) ABSTRACT

The present invention includes an audiovisual instructional module that includes one or more lessons on a computer readable medium, wherein each lesson provides instruction to one or more students for a pre-determined time, wherein each lesson is taught by an instructor with a teacher effectiveness index of more than one grade level per year of instruction and wherein the module permits a student to view the module one or more times and review any portion of the module one or more times in order to master the lesson.

### CROSS-REFERENCE TO RELATED APPLICATIONS

This application claims priority to U.S. Provisional Application Ser. No. 60/908,867, filed Mar. 29, 2007, the entire contents of which are incorporated herein by reference.

### TECHNICAL FIELD OF THE INVENTION

The present invention relates in general to the field of pedagogy, and more particularly, to novel methods, systems and learning modules that are student-centered in an asynchronous learning environment.

### BACKGROUND OF THE INVENTION

Without limiting the scope of the invention, its background is described in connection with high school education. For over 100 years, secondary education has been based on the One Best System (OBS), developed to move large numbers of workers from agricultural pursuits to factories. The One Best System was designed to provide basic skills to factory workers as part of a training regime that focused on repetition, set time events and the manufacturing of items in large amounts. However, this educational model was never intended or designed to put students on a college-ready path, but rather, on the road to manufacturing jobs in factories.

Variations of the One Best System have been adopted worldwide and are the primary model used for students that traverse from elementary, to middle, to high school. Typical features of the One Best System mirror those of an industrial setting. For example, both systems have a set start time, for the learning day ringing a bell, to begin work blowing a whistle. In school there is a set, equivalent time for each teaching event (a period) while in the factory there is a set time for each piece of the assembly line to be completed and passed on to the next stage. Both systems also include set morning breaks (brunch or break), a set lunch time and a set ending time.

While the model worked well during the industrialization stages of a nation, the One Best System has been unable to adapt to the modern information society. In the United States, for example, the decrease in manufacturing jobs renders the One Best Model obsolete, as large numbers of workers are no longer needed to run assembly plants and steel mills. In fact, large scale manufacturing is unlikely to return to the United States in the long-term future.

Today, we live in an information society, where students must learn to be adaptive and lifelong learners. No longer will a single set of skills be required throughout a lifetime or career. In fact, learning skills, adaptation, real-time education and improvement will be the hallmarks of future careers. The careers of the future will require retraining and education multiple times during the lifetime of an individual. Most of these careers will also require higher thinking skills, conceptualization, idea development, re-evaluation and analysis of information and the gathering and transfer of information.

One such system is taught in U.S. Pat. No. 6,356,437, issued to Mitchell, et al., for a system, apparatus and method for providing a portable customizable maintenance support instruction system. Briefly, an apparatus and method is disclosed that provides a user with task-specific information that includes a portable instruction system that may be worn by a user, and includes, a computer sufficiently lightweight and designed to be worn by a user to which a memory has been connected. The system includes a display device that can receive display signals from the computer for visual display to the user and an input device by which the user enters commands to the computer. An instructional program is provided that the computer accesses and stores in memory in response to a user command and displays information concerning a task to be performed by the user on the display device in response to commands from the user.

Another system is taught in United States Patent Application No. 20040110119, filed to Riconda, John R., et al., which teaches a web-based knowledge management system and method for education systems. A web-based, knowledge management system is taught for an education system that includes functionality for multi-tier data-gathering, data analysis, and data reporting capabilities that link, integrate, and output data at the student, classroom, school, district, and state governmental levels.

Yet another system is taught in United States Patent Application No. 20030182371, filed by Worthen, which teaches an asynchronous, leader-facilitated, collaborative networked communication system. The asynchronous, leader facilitated, collaborative networked communications system is taught with a secure website to which members of a community can connect using an Internet browser software program. Collaborative communication is begun by posting a member-initiated message to the website for a leader to review and determine whether at least a portion of the message should be broadcast to at least a portion of the membership. Broadcast of the message is preferably accomplished by notifying selected members about the message, such that the message is viewed by the selected members and a communications session among the selected members, member posting the message, and leader, via the secured website, is authorized.

Finally, United States Patent Application No. 20020076674, filed by Kaplan, is for a method and system for asynchronous online distributed problem solving including problems in education, business, finance, and technology. Briefly, systems and methods are taught for facilitating authoring and problem solving by joint contributors working separately but against a common goal. On-line asynchronous distributed authoring and problem-solving system, method, and computer program for focusing attention toward particular authoring and problem solving topics using a threaded discussion group and reward matrix. The present invention also includes a system, method, computer program and computer program product for coordinating the activities of a plurality of people, where the plurality may be any number from two to thousands or more people. Mechanism for directing the attention and focus of large numbers of people who are solving problems using a tree-based problem space, where the tree based problem space may be a virtual problem space. Algorithms and procedures for evaluating nodes in the virtual problem space and assigning values via a pay-off matrix that serves to focus the attention of large numbers of problem solvers. Combination of threaded discussion groups with the pay-off matrix and a variety of algorithms to create useful system for solving multi-level problems leveraging human expertise.

### SUMMARY OF THE INVENTION

The present invention provides for a new model for education that is centered on the needs of the student. The One Best System (OBS) currently in use throughout the world was designed to be a “one-size-fits-all” system. In contrast, the present invention provides methods and systems for identifying the individual student's learning needs, skills and desired career, creates a customized course offering and roadmap that is specific for the student and provides an asynchronous learning environment to complete that road map. The student-centered learning environment of the present invention is designed to provide a grade school to college graduation path in which the student will develop learning skills, acquire basic knowledge and will apply that knowledge in a controlled learning environment based on the student's aptitude, interests and skills. In certain embodiments, the learning environment is asynchronous and matches the learning requirements and needs of the student.

More particularly, the present invention addresses many of the challenges that face urban education in industrialized nations. For example, the present invention addresses the need to reach all levels of teaching needs, brings consistency to pedagogy based on best practices and a teacher effectiveness index, provides various modes of learning, follows curriculum strands of state required information and provides for a per pupil funding model.

The present invention includes an audiovisual instructional module that includes one or more lessons on a computer readable medium, wherein each lesson provides instruction to one or more students for a pre-determined time, wherein each lesson is taught by an instructor with a teacher effectiveness index of more than one grade level per year of instruction and wherein the module permits a student to view the module one or more times and review any portion of the module one or more times in order to master the lesson. Each module may also be used to train teachers to improve their teacher effectiveness index. The student may have access to one or more additional modules that include alternative lessons that use different teaching techniques for the same lesson. The instructional module follows one or more strands of a state required curriculum. The module is provided in a student controlled device, wherein the student controls the speed, return, advancement or repeat of the broadcast of the instructional module. The student is allowed to view the instructional modules as many times as required to master the material. a learning environment that includes one or more audiovisual instructional modules comprising one or more lessons that provide instruction to one or more students for a pre-determined time; determining which of the one or more students has mastered the skills taught by the learning module; and permitting those students that have mastered the learning skills to withdraw from the learning environment, thereby allowing any remaining students to receive additional instruction from an instructor or additional learning module that provides an alternative teaching method.

In another embodiment, the instruction is asynchronous. In another embodiment, the instructor captured in the learning module is selected from those with an above average teacher effectiveness index. The instructional module may follow one or more strands of a predetermined curriculum instruction. The teaching modules may be displayed on a projection screen, a hand-held device, a telephone, a heads-up display, glasses, an overhead projector, a projector or a computer screen. The instructional module is stored on a computer, on a magnetic tape, a DVD, a hard-drive, a flash-drive, a memory-stick, a film or a CD. As part of the project-based learning environment, the students are permitted to leave the learning environment proceed to a pre-designated area for continued instruction. In one embodiment, the departure of students that have mastered the instructional module decreases the student to teacher ratio for any remaining students during the remainder of the pre-determined time. In another embodiment, the students are grouped based on pre-determined groups of students with a common interest that matches their long-term career ambitions. In yet another embodiment, the environment is an elementary, middle or high school.

In one embodiment, the calculation of school funding is based on the delivery of each instructional module, per student. The instructional module may be broadcast to one or more viewing locations at the same time, broadcast upon request by the student, broadcast based on an instructor's selection, broadcast on a set schedule or broadcast in the same order as a curriculum strand. In one embodiment, the student controls the speed, return, advancement or repeat of the broadcast of the instructional module. In another embodiment, the student is placed in one or more project-based learning projects that match the student's long-term career goals at a college-ready level. In another embodiment, the student is tested for mastery of the instruction upon completion of the instructional module, after additional in-class instruction, following a pre-determined number of instructional modules, or at the end of a pre-determined number of teaching days. Under this new system, the student may be permitted to advance through the instructional modules regardless of chronological age. Using the present invention is that the student may be allowed to view the instructional modules as many times as required to master the material.

In another aspect, the present invention is a student-centered, asynchronous learning environment that includes working with a student to pre-determine one or more likely career paths for a student based on student aptitude and interest; grouping at one or more locations students based on their pre-selected career path or paths; allowing the student to advance at their own pace using one or more audiovisual instructional modules comprising one or more lessons that provide instruction to one or more students for a pre-determined time; and permitting those students that have mastered the learning skills to withdraw from a learning environment, wherein the student returns to a homeroom to continue work on one or more pre-determined career-based projects.

In another aspect, the present invention is a student pathway career map that includes matching a student to a career path based on the student's interest and aptitude in a career; providing the student with an adaptive instructional plan based on the student selected career path that meets all state requirements for course completion; grouping at one or more locations students based on their pre-selected career path or paths; permitting the student to advance to the completion of the state required courses asynchronously using one or more audiovisual instructional modules comprising one or more lessons that provide instruction to one or more students for a pre-determined time in a learning environment; and tracking the student's progress toward their course completion.

In another aspect, the present invention is a high school curriculum and instruction system by matching a student to a career path based on the student's interest and aptitude in a career; providing the student with an adaptive instructional plan based on the student selected career path that meets all state requirements for course completion; providing the student with one or more audiovisual instructional modules comprising one or more lessons that provide instruction to one or more students for a pre-determined time; determining which of the one or more students has mastered the skills taught by the learning module; and permitting those students that have mastered the learning skills to withdraw from the learning environment, thereby allowing any remaining students to receive additional instruction from an instructor or additional learning module that provides an alternative teaching method with a reduced pupil to teacher ratio; and directing the students that have mastered the skills to a common location in which students grouped based on their common career goal can work on one or more pre-determined career-based projects.

In another aspect, the present invention is a method of improving teacher effectiveness by training a teacher in pedagogy using one or more audiovisual instructional modules comprising one or more lessons taught by teachers with a high teacher effectiveness index for the subject of instruction. In one embodiment, the teacher has access to one or more additional modules that include alternative teaching techniques for the same subject matter. In another embodiment, the modules match one or more strands of a state required curriculum.

In another aspect, the present invention is a high school system that includes determining a preliminary curricular path for each student based on the student's interest and aptitude; providing the student with an adaptive instructional plan based on the student selected curricular path that meets all state requirements for course completion; placing the student with other students with a common curricular path and providing this student group with one or more learning projects focused around the common curricular path; providing the student with one or more audiovisual instructional modules comprising one or more lessons that provide instruction to one or more students for a pre-determined time less than a class period, wherein the instruction within the module is provided by one or more teachers with a high teacher effectiveness index; determining which of the one or more students has mastered the skills taught by the learning module; and permitting those students that have mastered the learning skills to withdraw from the learning environment, thereby allowing any remaining students to receive additional instruction from an instructor or additional learning modules that provides an alternative teaching method with a reduced pupil to teacher ratio. In one embodiment, the curricular paths are designed for each student based on one or more college-ready paths including: first-time college students, engineering/math/physics, information technology, medicine, biology, self-paced (students needing redirection, alternative schools), business entrepreneurship, post-college preparatory (law, business, medicine), language/multiculturalism, teaching and military.

In another aspect, the present invention is learning system adapted to present one or more learning modules that includes a hand-held device comprising visual input and output terminals, a heads-up display, individual auditory terminals, and networking capabilities, wherein a pupil controls the initiation of a learning event, replays or rewinds those portions of the instructional module that are required for the student to master the material provided within the instructional module, wherein the instructional module is taught by a teacher with a high classroom effectiveness index.

### BRIEF DESCRIPTION OF THE DRAWINGS

For a more complete understanding of the features and advantages of the present invention, reference is now made to the detailed description of the invention along with the accompanying figures and in which:

FIG. 1A shows the progression of students through various learning strands within the “One Best System” of the prior art, while FIG. 1B shows the student-centered, individualized instructional system of the present invention;

FIG. 2A shows the one-size-fits-all, four year graduation path for a student through various learning strands within the “One Best System” of the prior art, while FIG. 2B shows the student-centered, individualized, future-focused student graduation roadmap of the present invention;

FIG. 3A shows the general structure of a secondary school of the “One Best System” of the prior art, while FIG. 3B shows the project-based, career-focused, student-centered secondary school map of the present invention; and

FIG. 4 shows the integrated teaching approach of a project based learning environment, where the various disciplines coordinate to advance students through progressions of difficulty while addressing and integrating the various required strands of learning.

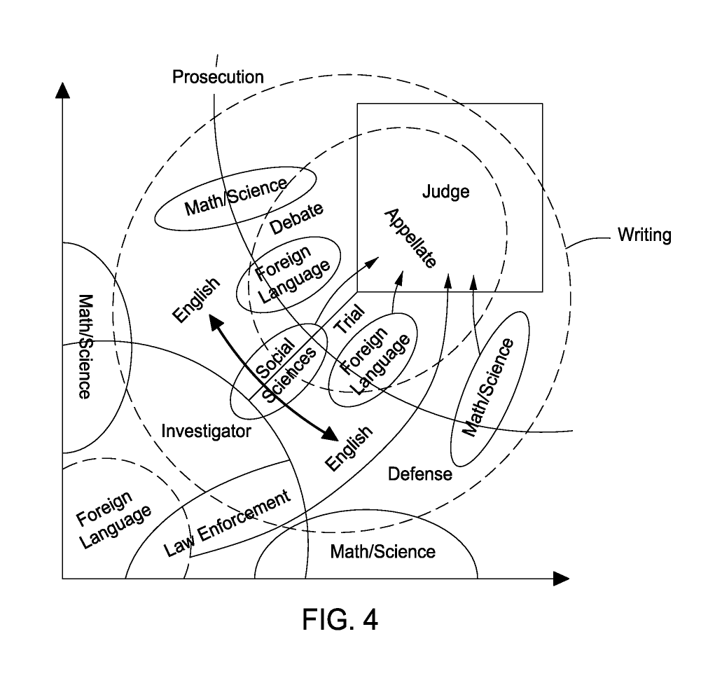

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, a “student pathway career map” refers to the long-term planning of a career path based on a student's individual interests. The student pathway career learning event that takes, e.g., 10-20 minutes. Each student can be provided with a hand-held or student-controlled device, audio and/or video devices and control over the learning event.

Each instructional module provided to each student is taught by the teacher or teachers with a high (and preferable the highest) classroom or teacher effectiveness index (TEI) available. The teacher effectiveness index is generally based on the ability of a teacher to maximize their students learning of that pedagogical block or event within the context of the state requirements for education, local requirements, cultural requirements, language skills of the students and the like. Generally, the teacher effectiveness index is based on the ability of the teacher to teach more than one grade level of instruction during one-year of instruction. On a lesson by lesson basis, a TEI can be determined by measuring the effectiveness of instruction of that same lesson when controlling for other variables related to the students being taught. For example, the variables may include the ethnicity, gender, age, level of English proficiency, socioeconomic status, current grade level, norm referenced test results, benchmark test results, state test results for the current and past years. Furthermore, various different modules may be provided for the same learning event for students that require a different type of pedagogy. That is, modules are customized for the type and learning ability of a student at a pace that is also controlled by the student. For example, the same instructional event related to learning a math equation and its uses may be taught in more than one way. For example, different students may be able to learn the equation and apply it by observing the instructional modules once, while other may have to rewind various times all or a portion of the module, some may need a different module that teaches the subject matter in a different way and some may require intervention by the teacher.

There are several factors that, to varying degrees and extents, play a role in the novel student-centered instructional system of the present invention. First, the teacher that delivers the pedagogy in the instructional model must engage the students in the learning event. While the students are participating in that learning event, e.g., at the beginning of the instructional time allotted to learning, the teacher can look at data for individual students, prepare additional materials for teaching those students that require more focused instruction, learn from the “master teacher” that is part of the instructional module, grade quizzes and exams and/or attend to other pedagogical or administrative matters. Once the instructional module has been completed, students can be evaluated to determine if they mastered the material and can withdraw from the learning environment and return to their project as the project-based learning environment location. By allowing those students that have mastered the material to withdraw from the room, the student to teacher ratio is reduced. For example, if a classroom has 25 students and 3 mastered the material in 15 minutes, then only 22 students remain. If after 30 minutes 12 more students have mastered the material, then the teacher and the remaining 10 students have an additional 15 to 20 minutes to continue the pedagogical event. It is during these remaining minutes that the teacher can bring forth the art of teaching. That is, these are the students that really need the hands-on, higher level instruction that teachers master over many years of training and experience.

It is often said that any teacher can teach the smart students, in fact, there are those that argue that the smart students require little if any teaching and guidance. By contrast, students that are more challenging require better teachers who are able to adapt to the specific needs of individual students, that are more in tune with the needs of the child, their home environment, their projection, other special needs and the variety in cultures, language and the like. For example, in urban school districts the mobility, diversity, language skills, environmental factors, pressures outside school (family, job, neighborhood, etc.) and the like are a greater challenge than more homogenous schools and districts. The individual instructional modules of the present invention can be provided to meet the individual needs of each student based on their needs, not the needs and/or limitations of the adults.

The individual instruction modules provide additional advantages. First, they decrease the inconsistency across classrooms by providing each student access to the best of the best pedagogy. Second, it permits students that are quick learners and/or have less time during a day because of outside pressures to be exposed to the best pedagogy in a shorted amount of time. For example, a student may learn the material in the individual instructional modules in six or seven 20 minute learning events and complete the educational day in less than three hours. Then the student can focus on their career-based learning project for another two hours and go to an internship or job shadowing event for two hours and return in time for band, football or other extracurricular activity. Some students may advance and complete the entire semester in six, nine or twelve weeks, allowing more time for other subjects in which the student is struggling or for which the student has a special interest (e.g., learn a new language, build a robot, lift weights, train for a marathon or teach students that are less advanced).

As used herein, a “strand” of education refers to a series of coherent, somewhat linear learning events that teach in step-wise manner material of increasing complexity. Generally, strands of education will be provided to the student such that learning events build the blocks for learning for subsequent learning events. For example, it is assumed that addition and subtraction skills are prerequisites for multiplication and division. As the skilled artisan will recognize, strands of education can be found within a course (e.g., algebra to geometry to pre-calculus to calculus), across grade levels (e.g., 2nd grade math to 3'd to 4th, etc.), and may be multi-disciplinary (e.g., using art to learn reading and math skills).

As used herein, a “learning environment” refers to a series of student-focused instructional events in which the student is guided through instructional modules at a pace that is based on their individual learning abilities within a subject. The learning event can be accomplished within an individual class period in which some students learn the material and move on to another subsequent or supplemental learning event. Upon completion of the task, the students can continue on to another learning event and/or may leave the learning environment and return to work on a career-focused project, e.g., a project based learning environment.

As used herein, an “asynchronous learning environment” refers to a series of student-focused instructional events in which the student is guided through instructional modules at a pace that is based on their individual learning abilities within a subject. Asynchronous learning can be found within an individual class period (which itself may be asynchronous, that is, of varying length) in which some students learn the material and move on to another subsequent or supplemental learning event. Alternatively, the students may leave the learning environment and return to work on a career-focused project, e.g., a project based learning environment. The instructional events can even be downloaded at the student's convenience while at home, traveling out of town, traveling in town (e.g., on the bus or subway), in-transit between schools, or as audio-only while driving (but not video unless the user is not in the front seat).

As used herein, a “project based learning environment” refers to a career-focused project that is cross-disciplinary (e.g., includes learning math, science, reading, social studies, etc., within a single project) that tracks and is directly relevant to the student's individual career path. Project-based learning projects can even pair students across so-called “grade levels” in a hands-on, interactive learning environment as is typical of the workforce.

A major problem with the OBS is that it assumes that student's must learn as individuals, while, the modular, project-based learning environment of the present invention is designed to more closely track the actual workplace of the future. The workplace of today and the future includes workers having different levels of skill (e.g., first-year associates, senior associates, junior partners and senior partners) each working on a part of an overall project under the leadership of a colleague. In the new educational system presented herein, students that are more advanced (regardless of chronological age) work hand-in-hand on a project with less advanced students to complete an overall project. As the student learns new skills and advances through the learning process, students with less experience, knowledge and/or skills (often but not always chronologically younger) work on a career-based project with the more knowledgeable student, which becomes as part of the learning environment a teacher.

As used herein, “Teachcasting” refers to a presentation that is directed to teaching students, which may include subroutines for varying learning needs, types of learning, methodology for teaching/learning a specific skill. Generally, teachcasts will be aligned to the curriculum and/or teaching tools that include the scope of instructional material to be delivered to a student. Depending on the specific requirements of a structured learning environment, e.g., a curriculum that is aligned to local, state or federally mandated requirements, a teachcast will be made available for each objective within a learning strand for each subject to be taught, e.g., mathematics, reading, science, social studies, foreign language, fine and performing arts, dual-language and the like. As the skilled artisan will recognize, teachcasts will be made available in the language of instruction for individual students, e.g., English-language learners will be provided instruction in the language of instruction depending on their level of skill and program for English language acquisition.

As used herein, “learncasting” refers to refers to a presentation that is directed to pedagogical tools for teachers, e.g., to learn teaching skills, teaching techniques, provide additional support for new and experienced teachers to address specific circumstances and/or the individualized needs of a student. Generally, learncasts will be aligned to the curriculum and/or teaching tools that include the scope of instructional material to be delivered to a student.

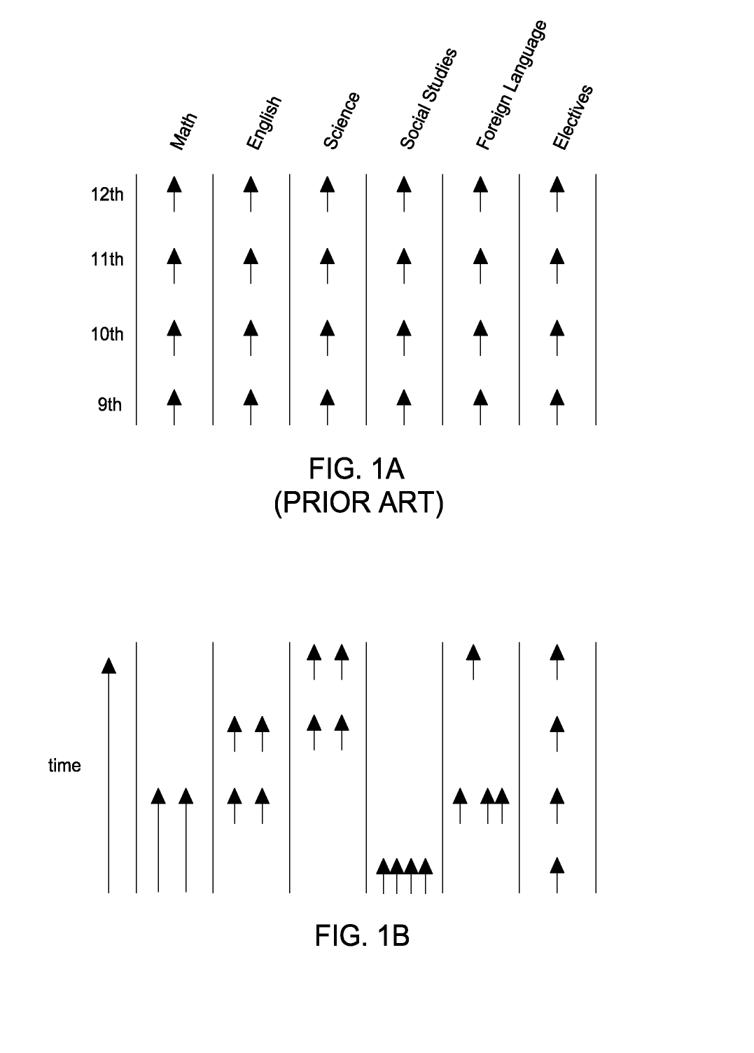

FIG. 1A shows the progression of students through various learning strands within the “One Best System” of the prior art. In the prior art, students follow a vertical strand of education from grade to grade without allowance for acceleration and/or to slow down to completely comprehend the material. Whether on a grade-by-grade vertical strand, or within a school year within a particular class, the One Best System “OBS” of the prior art is based on set timeframes for instruction in which students are expected to move forward at the same pace, in a linear progression through a lesson, a class and a grade level. While the OBS permitted for the supplementation of curriculum for talented and gifted students, as well as, students in need of additional help, the OBS incorporates these opportunities as an exception to the rule. However, the OBS assumes that the vast majority of students learn at the same pace in each strand of education.

FIG. 1B is a sharp departure from the OBS because the instruction is provided to each student based on the individual needs and learning abilities in each subject matter, for each student. Based on a student's “future map” shows the student-centered, individualized instructional system of the present invention;

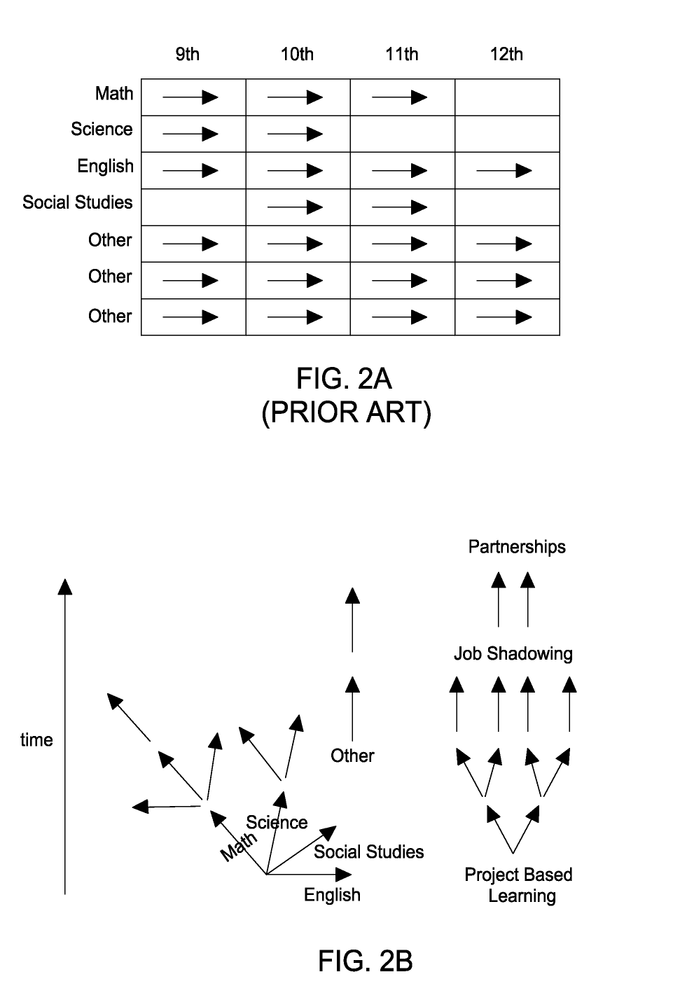

FIG. 2A shows the one-size-fits-all, four year graduation path for a student through various learning strands within the “One Best System” of the prior art. In the OBS, a student is limited in advancement by students that currently occupy the subsequent class with one more year of chronological age. The OBS accommodates students that are more advanced as an accommodation and not as part of the course of dealing, that is, as a matter of course that meet the student's individual needs. When a student falls behind and/or has challenges with acquiring specific learning skills within the chronological age-based OBS, they are in the way of students that are following the next year. That is, the student is trapped between the students that are a year ahead and those that are a year behind. Attached to falling behind, is the stigma associated with not advancing.

FIG. 2B shows the student-centered, individualized, future-focused student graduation roadmap of the present invention. In the system of the present invention, a student advances and takes courses based on their individual learning abilities, career-path needs and within an environment in which student mastery of the material is more important that chronological age. In fact, students can advance and complete certain complete strands of education in less that a semester or school year. In fact, with the modular learning system of the present invention, set time frames lose relevance as a student is not limited to a learning event by period, by class day, by semester, by school year or by chronological year. Using the modules and project-based learning environment of the present invention, students can meet and achieve their career path during the entire year, at home, at schools, while out of town, etc. Furthermore, students can rapidly advance in areas in which they have one or more particular talents, thereby providing additional time during a learning day or period to have additional (or different) instruction in which the student is struggling and/or needs to acquire larger amounts of knowledge (e.g., acquisition of necessary language skills).

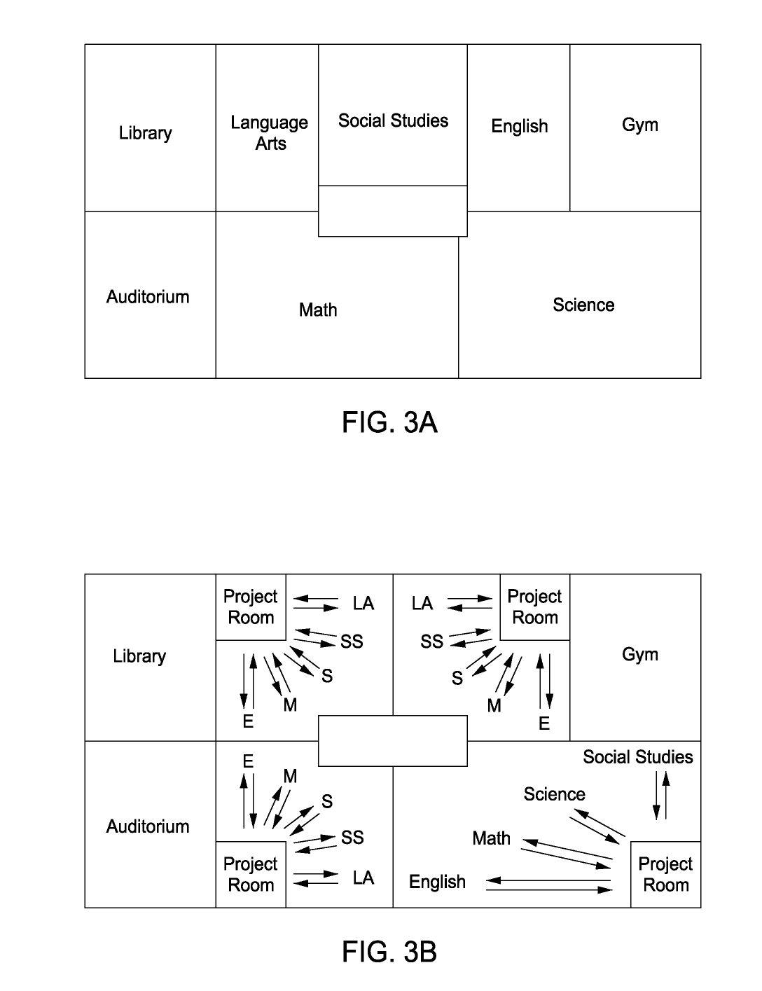

FIG. 3A shows the general structure of a secondary school of the “One Best System” of the prior art. In a typical secondary school lay out, e.g., a high school, the lay-out is based on the convenience of the adults, e.g., by having each department within the same hallway, corner or physical area. Students must traverse various hallways and even buildings to reach the next learning event, often with a stop at their locker somewhere in one of the hallways or buildings. Lockers, for example, are most often laid-out per grade level, that is, a 9th grade hallway will have all the 9th grade lockers, most often in alphabetical order. Again, the lay-out is based on the convenience of the adults and is strictly-based on chronological age in which all students, regardless of ability or interest, are treated exactly the same.

FIG. 3B shows the project-based, career-focused, student-centered secondary school map of the present invention. In this physical map, students are grouped based on their individual interests around one or more project-based learning environments and the teachers that support that learning environment are clustered around the students and their project. The physical configuration is critical to forming long-term relationships between student and faculty and between faculty and faculty in order to create cross-disciplinary shadowing and internships become integrated into the learning environment as described in Table 1. Table 1 shows exemplary career-focused secondary career path for project based learning.

TABLE 1

| Paths | Type | Focus |
|---|---|---|
| Revolution | Experimental | Focus on self-motivated, self-starting |
| High | school | students, regardless of part of |
| | | the school year, time and |
| | | location, schooling 24/7/365. |
| Freedom | First-time | Focus on parental involvement and |
| High | college | knowledge of the skills and steps |
| | | required to reach and |
| | | succeed in college |
| Discovery | Engineering/ | Focus on team-based technology |
| High | math/physics | projects, cross disciplinary training in |
| | | science, math and physics, hands-on |
| | | training, job shadowing and |
| | | internships at high technology |
| | | companies, including semi- |
| | | conductor, telecomm, |
| | | universities |
| Digital | Information | Focus on computer science, software |
| High | Technology | development, multi-media |
| Evolution | Medicine/ | Focus on biological sciences, math, |
| High | Biology | science and medicine, career path |
| | | toward allied health sciences, |
| | | pharmacy, medicine, nursing, |
| | | medical technology |
| Indepen- | Self-paced | Focus on students in need of |
| dence | | redirection, morning and evening |
| High | classes. | |
| Enterprise | Business | Focus on banking, finance, real |
| High | Entrepreneurship | estate, accounting and |
| | | business management. |
| Challenger | Post College Prep | Focus on students with a goal of |
| High | | post-graduate |
| | | research and development training. |
| United | Language, | Focus on expanded language skills, |
| Nations | multiculturalism | diplomacy, international |
| High | | relations, international business. |
| Aim High | Military | Focus on military sciences, |
| | | international relations and |
| | | multi-language and multi-culture |

Asynchronous learning environments (time-shifting) that permit students to learn in or outside specified timeframes, view and review podcasts multiple times. Students are no longer within preset grade levels, but rather, are within a portion of their learning materials based on their personal learning roadmap. Roadmap graduation occurs upon completion of the roadmap (in full compliance with State unit requirements) regardless of age.

Non-linear student tracking, evaluation and progress. Student may progress through various courses and at various times depending on their individual progress. Students can join “user groups” that are advancing at their pace by concentrating educational time and teacher interaction.

Thinkcast™: Each focused time-on-task lesson (targeted learning event), detailed instruction of specific times, with availability of immediate help and/or evaluation. Each Thinkcast™ is strictly aligned with TEKS and the required state curriculum. Each teacher has access to each Thinkcast™ across grade levels to participate in joint planning efforts, teaching prerequisites and maintaining educational cohesion in each grade level across strands.

Each teacher also participates in integrative teaching, where Thinkcasts, Learncasts and hard teaching materials are integrated to teach, simultaneously multiple skills and knowledge.

Clustered virtual and physical learning communities: clusters of students with same tomorrow(s) interact on a daily basis through competitive and non-competitive learning projects. Student clusters vie for job shadowing and internships.

Variable class sizes within a period: Thinkcasts are initiated and students that are capable of demonstrating mastery of the material return to their home base to continue work on their individual project. Students in need of additional hands-on instruction, remain with the teacher for more focused instruction and variation of teaching skills.

Variable class times. Students that advance beyond the timed module in the strand, as permitted to join other students that have reached a similar level of advancement for enrichment activities related to the subject matter and/or their project.

Master teacher sharing, reevaluation, sharing of best practices, alignment with TEKS, interdisciplinary training, teaching and learning.

Comprehensive Learning Projects (CLP): large project-based learning outside the targeted learning events (TLEs) that form part of a global college-workforce training project that matches the goals of the “Tomorrow” selected by the student. Students that master the material have an incentive to learn material and return to comprehensive learning project of their election. It is expected, but not a requirement, that project based learning will be introduced in elementary school and carried through the higher grades.

Dual-credit/AP courses are an integral and required part of each module. Courses and roadmap is selected beginning in 8th grade such that the student college interest and readiness plan is ready by 9th grade.

Life Counseling-academic counselors follow cohorts within a Tomorrow to achieve their academic/life goals. Counselors are selected and trained based on their personal knowledge and commitment to the Tomorrow module. Counselors may be non-academic that have extensive industry knowledge and contacts.

Pre-K-18 roadmaps—roadmaps begin to be discussed in early elementary years. Roadmap evaluations and testing begins in middle school and the roadmap plan is written and agreed to by the student in 9th grade. The college interest plan is determined and finalized before entering a High school. College selection and criteria for college admission are elected in 9th grade and progressed tracked every semester. Radar plots for progress are provided to each student toward with roadmap goal every 6 weeks. Tracking of college interest plan is reviewed every 6-12 weeks.

Year-long learning-asynchronous learning times and locations can be used to provide year-long teaching at selected locations for students in need of help, reconnection students, students that want to advance and students that were unable to complete the semester due to illness or other cause. High school sites are selected throughout the district to provide continued service through the summer.

For purposes of funding, e.g., payment by a city, county or state per student (in Texas, e.g., the average-daily-attendance or ADA) may be determined by Thinkcast use, that is, a certain amount of funding per single pod, per single cast. For students that require learning from more than one cast or individual learning event of an instructional module, additional funding may be determined for those learners in a manner that is a multiplier of the payment based on the needs of the students (in Texas the weighted-average-daily-attendance or WADA). For example, the WADA takes into account the additional funding required to teach an English-language learner (ELL student), Special Education students and Talented and Gifted (TAG) students. The determination of funding for the ADA can be based on the same state template and required units that form part of the state's educational curriculum. For example, in Texas the Texas Essential Knowledge and Skills (TEKS) is the state-mandated curriculum. For each required skill that a student must be taught and master, an individual learning module taught by the best teachers(s) in the district, region, state or country is generated for each portion of the TEKS. Whether math, science, language arts, fine arts, reading, English, foreign language, etc., students traverse their career-pathway in alignment with the TEKS and funded based on the TEKS. Furthermore, regardless of which state required testing regime exists at the time (in Texas, e.g., Texas Assessment of Academic Skills (TASS), followed by the Texas Assessment of Knowledge and Skills (TAKS) and perhaps end-of-year exams in the future) or state mandated curriculum, individual instructional modules can be created to meet and exceed the learning requirements by using the best teachers.

The selection of teachers per modules will be based on a variety of factors. Factors that will generally be included are, e.g., Teacher Effectiveness Index (TEI), student engagement, language skills, cultural skills, life experience, contact with industry.

Decentralized and/or asynchronous benchmarks may be used to track student progress. For example, the benchmarks may be designed to match the curriculum, to test individual skills, to check whether learning the skill was accomplished and/or to focus attention on missing prerequisite skills. The benchmarks may also be used to advance and/or challenge students that are achieving at higher levels. The benchmarks may even be performed on-line to provide immediate feedback to the student, teacher and/or administrators. The results can also be plotted on the students' academic roadmap and/or spider plot to provide a visual

Learning Projects are graded and also used to calculate ADA and WADA, count toward certain percentage of final grade. Based on changes in the legislature toward end of year/semester exams (EOYE), these projects could be used to satisfy state requirements for EOYE. Projects will cross multiple disciplines and provide integration of the learning experience because students have to participate and perform all the skills that fall within the project guidelines for inter-disciplinary training.

Learning Commander: interactive, digital video and sound player that conforms to multiple digital and sound files, allows students to advance and return to part or all of the lesson.

Building reconfiguration. Buildings will be set-up like a college campus, with areas of interest grouped within physical locations based on the Tomorrow unit. Each Tomorrow Unit is provided with a project based learning location, a counseling unit location. A separate area may be provided for standard structured, timed learning.

Staff reconfiguration. Staff is aligned across disciplines within a Tomorrow module. Integrative classes may be taught concurrently to advance one or both classes in “ad hoc” block schedule. Interactive tomorrow project learning can occur without interruption of bells and other time constraints on certain days, which other days follow the regular time schedule. Modules that elect to eliminate set time schedules may do so, so long as additional one-on-one instruction is provided following the Thinkcast time. Students may participate in Thinkcasts at other times within their module (or outside with permission) based on timing of the classes and location.

Another distinct advantage of the present invention is that it repurposes many of the existing faculty to align with the needs of the students. The present invention places a greater emphasis on the art of teaching and less on rote drilling for standardized exams. Furthermore, the faculty and staff will align with areas that are of personal interest to them, rather than the one-size-fits-all curriculum currently in place in most schools. By realigning the faculty into project-based learning environments, the faculty is also able to develop those contacts in the local area that will be the conduit for future job opportunities for their students, including: equipment, training, mentoring, job shadowing and internships.

In summary, the present invention includes: an audiovisual instructional module comprising one or more lessons on a computer readable medium, wherein each lesson provides instruction to one or more students for a pre-determined time, wherein each lesson is taught by an instructor with a teacher effectiveness index of more than one grade level per year of instruction and wherein the module permits a student to view the module one or more times and review any portion of the module one or more times. The module is provided in a student controlled device, wherein the student controls the speed, return, advancement or repeat of the broadcast of the instructional module. The student is allowed to view the instructional modules as many times as required to master the material.

The invention also includes a learning environment comprising: one or more audiovisual instructional modules comprising one or more lessons that provide instruction to one or more students for a pre-determined time; determining which of the one or more students has mastered the skills taught by the learning module; and permitting those students that have mastered the learning skills to withdraw from the learning environment, thereby allowing any remaining students to receive additional instruction from an instructor or additional learning module that provides an alternative teaching method. The environment of instruction is asynchronous. The instructor captured in the learning module is selected from those with an above average teacher effectiveness index. The instructional module follows one or more strands of a predetermined curriculum instruction. The teaching modules may be displayed on a projection screen, a hand-held device, a telephone, a heads-up display, glasses, an overhead projector, a projector or a computer screen. The instructional module may be stored on a computer, on a magnetic tape, a DVD, a hard-drive, a flash-drive, a memory-stick, a film or a CD. The students may be permitted to leave the learning environment proceed to a pre-designated area for continued instruction. The departure of students that have mastered the instructional module decreases the student to teacher ratio for any remaining students during the remainder of the pre-determined time. The students are grouped based on predetermined groups of students with a common interest that matches their long-term career ambitions. The environment is an elementary, middle or high school. A calculation of school funding is based on the delivery of each instructional module, per student, e.g., that is delivered and mastered. An instructional module may be broadcast to one or more viewing locations at the same time, broadcast upon request by the student, broadcast based on an instructor's selection, broadcast on a set schedule or broadcast in the same order as a curriculum strand. The student controls the speed, return, advancement or repeat of the broadcast of the instructional module. The student is placed in one or more project-based learning projects that match the student's long-term career goals at a college-ready level. The student is tested for mastery of the instruction upon completion of the instructional module, after additional in-class instruction, following a pre-determined number of instructional modules, or at the end of a pre-determined number of teaching days. The student is permitted to advance through the instructional modules regardless of chronological age. The student is allowed to view the instructional modules as many times as required to master the material.

The present invention is also a student-centered, asynchronous learning environment comprising: pre-determining one or more likely career paths for a student based on student aptitude and interest; grouping at one or more locations students based on their pre-selected career path or paths; allowing the student to advance at their own pace using one or more audiovisual instructional modules comprising one or more lessons that provide instruction to one or more students for a pre-determined time; and permitting those students that have mastered the learning skills to withdraw from a learning environment, wherein the student returns to a homeroom to continue work on one or more pre-determined career-based projects. A student pathway career map comprising: matching a student to a career path based on the student's interest and aptitude in a career; providing the student with an adaptive instructional plan based on the student selected career path that meets all state requirements for course completion; grouping at one or more locations students based on their pre-selected career path or paths; permitting the student to advance to the completion of the state required courses asynchronously using one or more audiovisual instructional modules comprising one or more lessons that provide instruction to one or more students for a pre-determined time in a learning environment; and tracking the student's progress toward their course completion.

The present invention is also a high school curriculum and instruction system comprising: matching a student to a career path based on the student's interest and aptitude in a career; providing the student with an adaptive instructional plan based on the student selected career path that meets all state requirements for course completion; providing the student with one or more audiovisual instructional modules comprising one or more lessons that provide instruction to one or more students for a pre-determined time; determining which of the one or more students has mastered the skills taught by the learning module; and permitting those students that have mastered the learning skills to withdraw from the learning environment, thereby allowing any remaining students to receive additional instruction from an instructor or additional learning module that provides an alternative teaching method with a reduced pupil to teacher ratio; and directing the students that have mastered the skills to a common location in which students grouped based on their common career goal can work on one or more pre-determined career-based projects.

Another embodiment of the present invention is a method of improving teacher effectiveness comprising: training a teacher in pedagogy using one or more audiovisual instructional modules comprising one or more lessons taught by teachers with a high teacher effectiveness index for the subject of instruction. The teacher has access to one or more additional modules that include alternative teaching techniques for the same subject matter. The modules match one or more strands of a state required curriculum.

Yet another embodiment of the present invention is a high school or secondary school system comprising: determining a preliminary curricular path for each student based on the student's interest and aptitude; providing the student with an adaptive instructional plan based on the student selected curricular path that meets all state requirements for course completion; placing the student with other students with a common curricular path and providing this student group with one or more learning projects focused around the common curricular path; providing the student with one or more audiovisual instructional modules comprising one or more lessons that provide instruction to one or more students for a pre-determined time less than a class period, wherein the instruction within the module is provided by one or more teachers with a high teacher effectiveness index; determining which of the one or more students has mastered the skills taught by the learning module; and permitting those students that have mastered the learning skills to withdraw from the learning environment, thereby allowing any remaining students to receive additional instruction from an instructor or additional learning modules that provides an alternative teaching method with a reduced pupil to teacher ratio. The curricular paths are designed for each student based on one or more college-ready paths including: first-time college students, engineering/math/physics, information technology, medicine/biology, self-paced (students needing redirection, alternative schools), business entrepreneurship, post-college preparatory (law, business, medicine), language, multiculturalism, teaching and military.

Another embodiment is a learning system adapted to present one or more learning modules comprising: a hand-held device comprising visual input and output terminals, a heads-up display, individual auditory terminals, and networking capabilities, wherein a pupil controls the initiation of a learning event, replays or rewinds those portions of the instructional module that are required for the student to master the material provided within the instructional module, wherein the instructional module is taught by a teacher with a high classroom effectiveness index.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the method being employed to determine the value or variation.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the methods disclosed and claimed herein can be made and executed without undue experimentation in light of the present disclosure. While the methods of this invention have been described in terms of certain embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. An audiovisual instructional module comprising:
one or more lessons on a computer readable medium, wherein each lesson provides instruction to one or more students for a pre-determined time, wherein each lesson is taught by an instructor with a teacher effectiveness index of more than one grade level per year of instruction and wherein the module permits a student to view the module one or more times and review any portion of the module one or more times in order to master the lesson.

2. The module of claim 1, wherein each module is used to train teachers to improve their teacher effectiveness index.

3. The module of claim 1, wherein the student has access to one or more additional modules that include alternative lessons that use different teaching techniques for the same lesson.

4. The environment of claim 1, wherein the instructional module follows one or more strands of a state required curriculum.

5. The environment of claim 1, wherein the module is provided in a student controlled device, wherein the student controls the speed, return, advancement or repeat of the broadcast of the instructional module.

6. The environment of claim 1, wherein the student is allowed to view the instructional modules as many times as required to master the material.

7. A learning environment comprising:
one or more audiovisual instructional modules comprising one or more lessons that provide instruction to one or more students for a pre-determined time, wherein the instructional module displays one or more instructors that have a teacher effectiveness index of more than one grade level per year of instruction;
permitting the student to control the speed, return, advancement or repeat of the broadcast of the instructional module;
determining which of the one or more students has mastered the skills taught by the learning module; and
permitting those students that have mastered the learning skills to withdraw from the learning environment, thereby allowing any remaining students to receive additional instruction from an instructor or additional learning module that provides an alternative teaching method.

8. The environment of claim 7, wherein the instructional module follows one or more strands of a state required curriculum.

9. The environment of claim 7, wherein the students are grouped based on self-selected groups of students with a common interest that aligns with a career.

10. The environment of claim 7, wherein the environment is an elementary, middle or high school.

11. The environment of claim 7, wherein a calculation of school funding is based on the delivery of each instructional module, per student.

12. The environment of claim 7, wherein instructional module is broadcast to one or more viewing locations at the same time, broadcast upon request by the student, broadcast based on an instructor's selection, broadcast on a set schedule or broadcast in the same order as a curriculum strand.

14. The environment of claim 7, wherein the student is placed in one or more project-based learning projects that align with the student's long-term career goals at a college-ready level.

15. The environment of claim 7, wherein the student is tested for mastery of the instruction upon completion of the instructional module, after additional in-class instruction, following a pre-determined number of instructional modules, or at the end of a pre-determined number of teaching days.

16. The environment of claim 7, wherein the student is allowed to view the instructional modules as many times as required to master the material.

17. A student-centered, asynchronous learning environment comprising:
pre-determining one or more likely career paths for a student based on student aptitude and interest;
grouping at one or more locations students based on their pre-selected career path or paths;
allowing the student to advance at their own pace using one or more audiovisual instructional modules comprising one or more lessons that provide instruction to one or more students for a pre-determined time, wherein each module comprises instruction from a teacher with a teacher effectiveness index of more than one grade level per year of instruction; and
permitting those students that have mastered the learning skills to withdraw from a learning environment, wherein the student returns to a homeroom to continue work on one or more pre-determined career-based projects.

18. The environment of claim 18, wherein the school is a high school, and the environment further comprises providing the student with an adaptive instructional plan based on the student selected career path that meets all state requirements for course completion.

19. The environment of claim 18, wherein the modules are taught by the teachers with the highest effectiveness index in the school or school district in which instruction is taking place.
